(19) United States
(12) Patent Application Publication
(10) Pub. No.: US 2008/0136997 A1
(43) Pub. Date: Jun. 12, 2008

(54) LIQUID CRYSTAL DISPLAY DEVICE

(76) Inventors: Chih-Li Chang, Tai-Nan City (TW); Cheng-Chia Wu, Taipei County (TW); Hung-Chen Kao, Tao-Yuan Hsien (TW)

Correspondence Address: NORTH AMERICA INTELLECTUAL PROPERTY CORPORATION, P.O. BOX 506, MERRIFIELD, VA, 22116, US

(21) Appl. No.: 11/567,720

(22) Filed: Dec. 6, 2006

(51) Int. Cl. G02F 1/1335; G02F 1/13357

(52) U.S. Cl. 349/62; 349/95

(57) ABSTRACT

A liquid crystal display device has an upper prism sheet and a lower polarizer disposed on the upper prism sheet. The upper prism sheet has a plurality of first parallel ridgelines arranged in a first direction and a light-condensing direction. The first direction of the first parallel ridgelines is substantially perpendicular to the light-condensing direction. The lower polarizer has a first transmissive axis substantially parallel to the light-condensing direction.

### BACKGROUND OF THE INVENTION

1. Field of the Invention

The present invention relates to a liquid crystal display (LCD) device, and more particularly to an LCD device in which the light-condensing direction of an upper prism sheet and the transmissive axis of a lower polarizer are substantially parallel.

2. Description of the Prior Art

Generally, an LCD is mostly used type of flat panel display. Especially the small size, lighter weight, high luminance, high contrast and lower power consumption render the LCD to replace the cathode ray tube (CRT). The LCD is currently used as a monitor for laptop computer and even for a desktop computer, gaining its popularity. However, LCD panels are not self-luminescent, a backlight module including light source and optical films play an important roles in LCD panels to provide excellent optical performance such as high luminance, high contrast and wide viewing angle.

Please refer to FIG. 1, which is an exploded view of a conventional LCD device of the prior art. As shown in FIG. 1, a conventional LCD device 10 includes a backlight module 11, a liquid crystal panel 12, a lower polarizer 16 disposed on bottom surface of the liquid crystal panel 12, and an upper polarizer 18 disposed on top surface of the liquid crystal panel 12. The backlight module 11 includes a pair of prism sheets 13,14 disposed under the lower polarizer 16, a diffuser sheet 112 disposed under the prism sheets 13, 14, a light guide plate 114 disposed under the diffuser sheet 112, and a light source 116 disposed on an edge of the light guide plate 114. In the conventional LCD device 10, the pair of prism sheets 13, 14 include an upper prism sheet 13 having a plurality of parallel ridgelines arranged in a vertical direction and a lower prism sheet 14 having a plurality of parallel ridgelines arranged in a horizontal direction. The lower prism sheet 14 is disposed on the diffuser sheet 112 and the upper prism sheet 13 is disposed on the lower prism sheet 14. The lower polarizer 16 has a first transmissive axis and the upper polarizer 18 has a second transmissive axis perpendicular to the first transmissive axis. In general, the first transmissive axis is disposed to form an included angle about 45 degrees with respect to an edge of the liquid crystal panel 12. Light emitted from the light source 116 penetrates through the lower prism sheet 14 and then penetrates through the upper prism sheet 13. Because light from the light source 116 will be partial refracted and diffusely reflected, partial light will be wasted. Therefore, in order to offer sufficient contrast and luminance and reduce power consumption, to gain more light from the light source is an important task needed to achieve.

### SUMMARY OF THE INVENTION

It is therefore a primary object of the present invention to provide an LCD device that can utilize the light energy of a light source more efficiently.

According to an embodiment of the present invention, an LCD device in which the light-condensing direction of an upper prism sheet and the transmissive axis of a lower polarizer are substantially parallel is provided. The LCD device includes an upper prism sheet and a lower polarizer disposed on the upper prism sheet, and the upper prism sheet has a plurality of first parallel ridgelines arranged in a first direction and a light-condensing direction. The first direction of the first parallel ridgelines is substantially perpendicular to the light-condensing direction. The lower polarizer has a first transmissive axis substantially parallel to the light-condensing direction.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an exploded view of a conventional LCD device of the prior art.

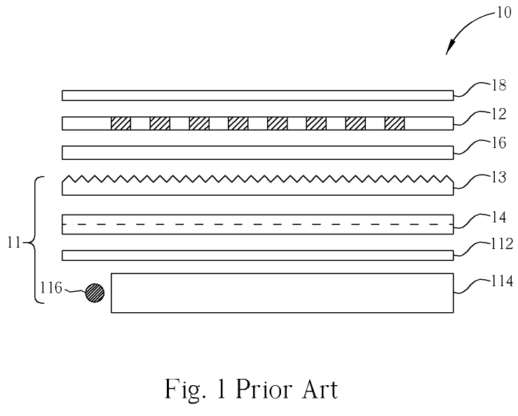

FIG. 2 is an exploded view of an LCD device according to a first embodiment of the present invention.

FIG. 3 is an experiment result of the embodiment according to definition of FIG. 4.

FIG. 4 is a definition of an angle of arrangement direction.

FIG. 5 is an exploded view of an LCD device according to a second embodiment of the present invention.

FIG. 6 is an exploded view of an LCD device according to a third embodiment of the present invention.

FIG. 7 is an exploded view of an LCD device according to a fourth embodiment of the present invention.

FIG. 8 is an exploded view of an LCD device according to a fifth embodiment of the present invention.

FIG. 9 is an exploded view of an LCD device according to a sixth embodiment of the present invention.

### DETAILED DESCRIPTION

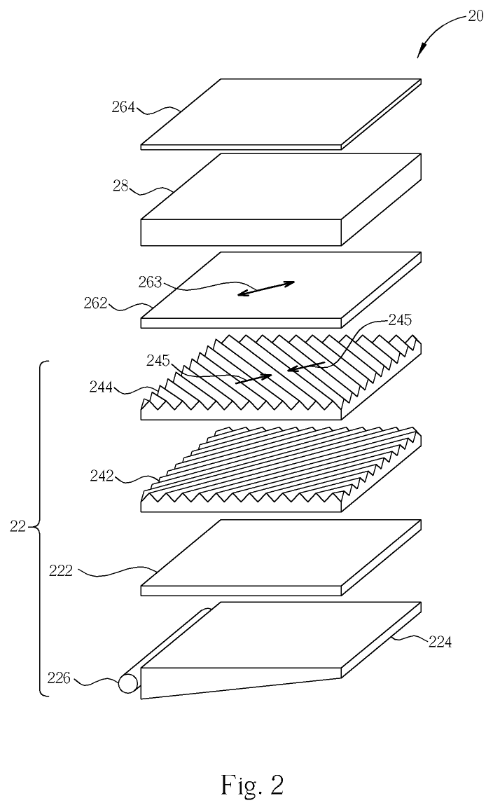

Please refer to FIG. 2, which is an exploded view of an LCD device according to a first embodiment of the present invention. As shown in FIG. 2, an LCD device 20 includes a backlight module 22, a liquid crystal panel 28, a lower polarizer 262 disposed under the liquid crystal panel 28, and an upper polarizer 264 disposed on the liquid crystal panel 28. The liquid crystal panel 28 includes a color filter, a plurality of liquid crystal molecules and a plurality of thin film transistors (not shown in figure). The backlight module 22 includes an upper prism sheet 244 disposed under the lower polarizer 262, a lower prism sheet 242 disposed under the upper prism sheet 244, a diffuser sheet 222 disposed under the lower prism sheet 242, a light guide plate 224 disposed under the diffuser sheet 222 and a light source 226 disposed on an edge of the light guide plate 224. According to the position of the light source, the backlight module 22 of the embodiment is edge lighting type. The upward surface of the upper prism sheet 244 has a plurality of first parallel ridgelines arranged in a first direction, and the upper prism sheet 244 has a first light-condensing direction 245, along which the incident light is condensed, perpendicular to the first direction of the first parallel ridgelines. The upward surface of the lower prism sheet 242 has a plurality of second parallel ridgelines arranged in a second direction, and the lower prism sheet 242 has a second light-condensing direction perpendicular to the second direction of the second parallel ridgelines. In operation, in order to condense light emitted uniformly from the diffuser sheet 222, the second direction of the second parallel ridgelines is disposed substantially perpendicular to the first direction of the first parallel ridgelines. In addition, the lower polarizer 262 has a first transmissive axis 263, and the upper polarizer 264 has a second transmissive axis. The first transmissive axis 263 of the lower polarizer 262 is disposed substantially perpendicular to the second transmissive axis of the upper polarizer 264, and the first light-condensing direction 245 is disposed substantially parallel to the first transmissive axis 263 of the lower polarizer 262. The first transmissive axis 263 of the lower polarizer 262 can have an acute included angle in the range of 20 to 60 degrees with respect to an edge of the liquid crystal panel 28. In this embodiment, the first transmissive axis 263 of the lower polarizer 262 and an edge of the liquid crystal panel 28 are disposed to form an acute included angle substantially 45 degrees.

In this embodiment, light emitted from the light source 226 will be guided by the light guide plate 224. Then, the light will enter the diffuser sheet 222, and be diffused uniformly by the diffuser sheet 222. Therefore, the light will emit uniformly from top surface of the diffuser sheet 222. When the uniform light penetrates the lower prism sheet 242 and the upper prism sheet 244, the light will be partly refracted towards viewer and partly experienced total reflection and return to backlight. The light of partly returns to backlight will be through diffuse reflections and may be transmitted by prism sheets or returned to backlight for further recycling. So the use of light will be more effectively and the exit angle of light from a diffuse backlight becomes condensed. Most of the light through the prism sheets 244, 242 is condensed in the first and second light-condensing directions 245 and is refracted to the viewer. Next, because the lower polarizer 262 has the first transmissive axis 263, the light emitted out of the upper prism sheet 244 having a polarization direction substantially the same as the first transmissive axis 263 will penetrate the lower polarizer 262. Therefore, when the first transmissive axis 263 of the lower polarizer 262 is substantially parallel to the first light-condensing direction 245 of the upper prism sheet 244, most of the light can pass through the lower polarizer. In order to prove the effect, an experiment result is provided as follows.

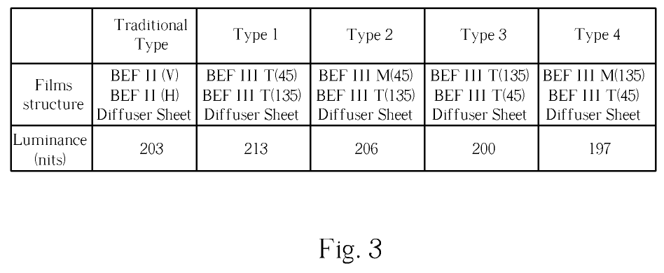

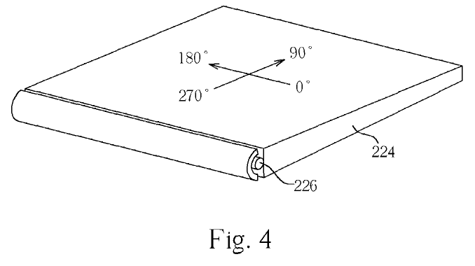

Please refer to FIG. 3 and FIG. 4. FIG. 3 is an experiment result of the embodiment according to definition of FIG. 4. FIG. 4 is a definition of an angle of arrangement direction. In this embodiment, the upper and lower prism sheets 244,242 use 3M's brightness enhancement films (BEF) such as BEF II film, BEF III-T film and BEF III-M film, but is not limited to these films. The experiment has five cases using two BEF II films and diffuser to compare with combinations of BEF III-T film, BEF III-M film and diffuser with differently arranged direction. The five cases have an identical condition. That is, the first transmissive axis 263 of the lower polarizer 262 is disposed at 45 degrees according to FIG. 4. The five cases are described as follows. The case of traditional type has conditions of the upper and lower prism sheets 244,242 being BEF II films, the first direction of the upper prism sheet 244 disposed in a vertical direction, and the second direction of the upper prism sheet 244 disposed in a horizontal direction. The case of type 1 has conditions of the upper and lower prism sheets 244,242 being BEF III-T films, the first light-condensing direction disposed at 45 degrees, and the second light-condensing direction disposed at a 135 degrees direction. The case of type 2 has conditions of the upper prism sheet 244 being BEF III-M film, the lower prism sheet 242 being BEF III-T film, the first light-condensing direction being disposed at 45 degrees, and the second light-condensing direction disposed at 135 degrees. The case of type 3 has conditions of the upper and lower prism sheets 244,242 being BEF III-T films, the first light-condensing direction disposed at 135 degrees, and the second light-condensing direction disposed at 45 degrees. The case of type 4 has conditions of the upper prism sheet 244 being BEF III-M film, the lower prism sheet 242 being BEF III-T film, the first light-condensing direction disposed at 135 degrees, and the second light-condensing direction disposed at 45 degrees. In addition, the BEF III film is utilizing a random prism structure eliminates wet-out and reduces reflective moiré effect, and the BEF II employs two principles-refraction and reflection to increase the efficiency of the backlight module. The light efficiency of BEF II film is better than that of BEF III film, so does the luminance. And, the cost of BEF II is higher than BEF III. In the BEF III film, the BEF III-M film has a matte layer to soften the brightness fall-off at the edges, so the luminance of BEF III-T film is higher than that of BEF III-M film. As shown in FIG. 3, the cases of type 1 and type 2 have higher luminance than the other cases. Comparing the type 1 and type 2 with the others, the type 1 and type 2 are the first light-condensing direction of the upper prism sheet 244 disposed at 45 degrees and the others are the first light-condensing direction of the upper prism sheet disposed not at 45 degrees. Therefore, when the first light-condensing direction of the upper prism sheet 244 is disposed at 45 degrees parallel to the first transmissive axis 263 of the lower polarizer 262, the luminance of the LCD device will increase. Also, if the BEF III film is used to replace the BEF II film, the cost of the LCD device can be reduced.

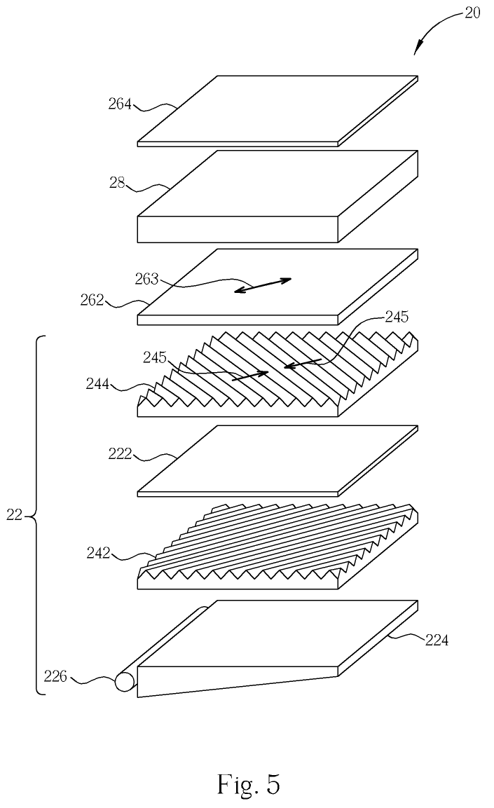

The above-mentioned embodiment is an LCD device with a kind of arrangement, and the present invention also includes several kinds of arrangements. Please refer to FIGS. 5 through 9, which are schematic diagrams of an LCD device according to other embodiments of the present invention. In the following description, the device components of each embodiment have been detailed in the above-mentioned embodiment. Therefore, redundant description is not included. Besides, in order to compare the difference of each embodiment according to the present invention, the devices in FIGS. 5 through 9 will use the same reference characters as the ones in FIG. 2 where appropriate.

Please refer to FIG. 5, which is an exploded view of an LCD device according to a second embodiment of the present invention. As shown in FIG. 5, the diffuser sheet 222 is disposed between the upper prism sheet 244 and the lower prism sheet 242, and the backlight module 22 includes the light guide plate 224 disposed under the lower prism sheet 242 and the light source 226 disposed on an edge of the light guide plate 224.

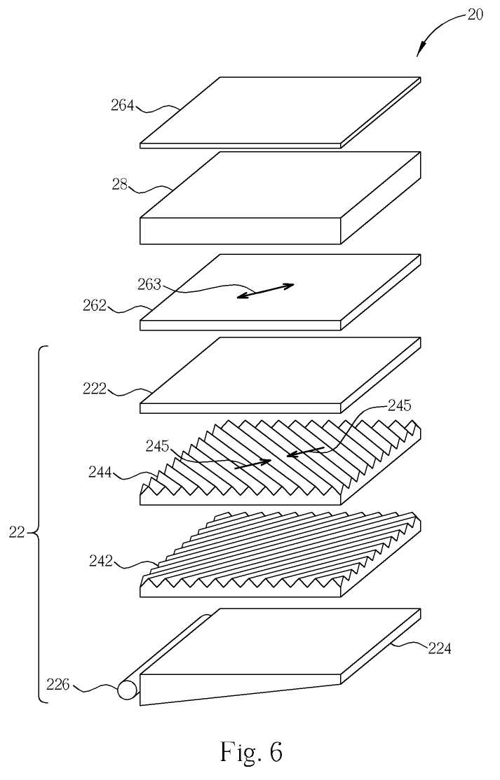

Please refer to FIG. 6, which is an exploded view of an LCD device according to a third embodiment of the present invention. As shown in FIG. 6, the diffuser sheet 222 is disposed between the upper prism sheet 244 and the lower polarizer 262, and the backlight module 22 includes the light guide plate 224 disposed under the lower prism sheet 242 and the light source 226 disposed on an edge of the light guide plate 224.

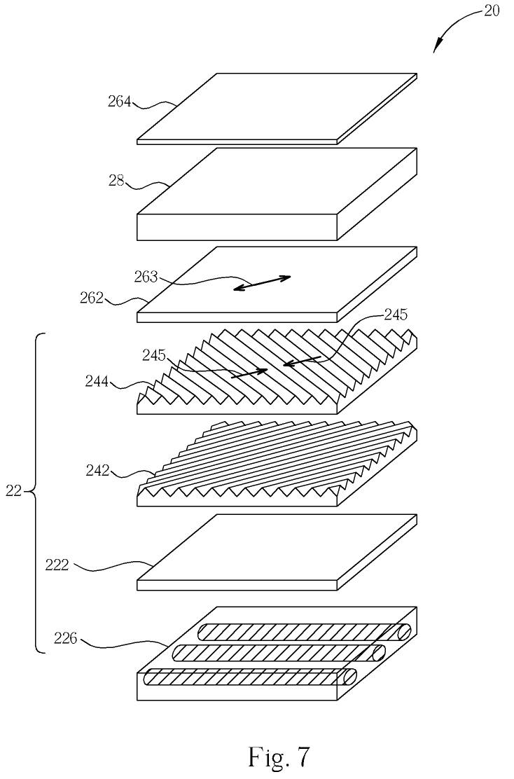

Please refer to FIG. 7, which is an exploded view of an LCD device according to a fourth embodiment of the present invention. As shown in FIG. 7, the light source 226 included in the backlight module 22 is disposed under the diffuser 222, so the backlight module 22 is direct lighting type.

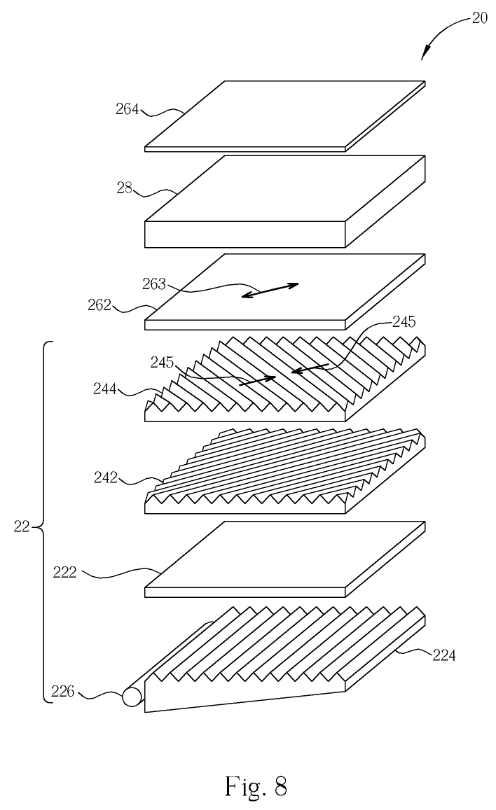

Please refer to FIG. 8, which is an exploded view of an LCD device according to a fifth embodiment of the present invention. As shown in FIG. 8, the light guide plate 224 has a plurality of microstructures formed on an upward side of a top surface of the light guide plate 224, and the microstructures are a plurality of v-cut grooves.

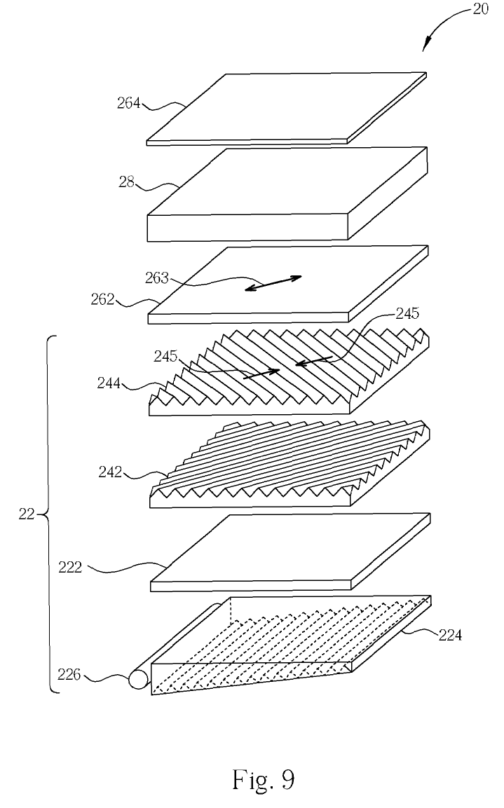

Please refer to FIG. 9, which is an exploded view of an LCD device according to a sixth embodiment of the present invention. As shown in FIG. 9, the light guide plate 224 has a plurality of microstructures formed on an upward side of a bottom surface of the light guide plate 224, and the microstructures are a plurality of v-cut grooves. It is to be appreciated that the shape of the microstructures of the light guide plate 224 or the pattern of the prism sheets is not limited to the aforementioned embodiments, and can be modified where necessary.

In summary, the LCD device of the present invention provides the light-condensing direction of an upper prism sheet and the transmissive axis of a lower polarizer substantially parallel to each other to improve the light efficiency so that the luminance and the cost can be reduced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A liquid crystal display device, comprising:
an upper prism sheet having a plurality of first parallel ridgelines arranged in a first direction and a light-condensing direction, the first direction of the first parallel ridgelines being substantially perpendicular to the light-gathering direction; and
a lower polarizer disposed on the upper prism sheet, the lower polarizer having a first transmissive axis substantially parallel to the light-condensing direction.

2. The liquid crystal display device of claim 1, further comprising a liquid crystal panel disposed on the lower polarizer.

3. The liquid crystal display device of claim 2, wherein the first transmissive axis and an edge of the liquid crystal panel form an acute included angle in the range of 20 to 60 degrees.

4. The liquid crystal display device of claim 3, further comprising an upper polarizer disposed on the other side of the liquid crystal panel opposite to the lower polarizer, the upper polarizer having a second transmissive axis.

5. The liquid crystal display device of claim 4, wherein the second transmissive axis is substantially perpendicular to the first transmissive axis.

6. The liquid crystal display device of claim 1, further comprising a lower prism sheet disposed on the other side of the upper prism sheet opposite to the lower polarizer, the lower prism sheet having a plurality of second parallel ridgelines.

7. The liquid crystal display device of claim 6, wherein the second parallel ridgelines are arranged in a second direction substantially perpendicular to the first direction of the first parallel ridgelines.

8. The liquid crystal display device of claim 6, further comprising a diffuser sheet disposed on the other side of the lower prism sheet opposite to the upper prism sheet.

9. The liquid crystal display device of claim 6, further comprising a diffuser sheet disposed between the upper prism sheet and the lower prism sheet.

10. The liquid crystal display device of claim 6, further comprising a diffuser sheet disposed between the upper prism sheet and the lower polarizer.

11. The liquid crystal display device of claim 8, further comprising a light guide plate disposed under the diffuser sheet.

12. The liquid crystal display device of claim 11, further comprising a light source disposed on an edge of the light guide plate.

13. The liquid crystal display device of claim 11, further comprising a plurality of microstructures formed on the top surface of the light guide plate, the microstructures being a plurality of v-cut grooves.

14. The liquid crystal display device of claim 11, further comprising a plurality of microstructures formed on a side of the bottom surface facing the top surface of the light guide plate, the microstructures being a plurality of v-cut grooves.

15. The liquid crystal display device of claim 8, further comprising a light source disposed under the diffuser sheet.
